(19) United States
(12) Patent Application Publication
(10) Pub. No.: US 2021/0247847 A1
(43) Pub. Date: Aug. 12, 2021

(54) METHOD OF OPERATING FUNCTION BASED ON GESTURE RECOGNITION AND ELECTRONIC DEVICE SUPPORTING SAME

(71) Applicant: Samsung Electronics Co., Ltd., Suwon-si (KR)

(72) Inventors: Juhyun KO, Suwon-si (KR); Sooyoun PARK, Suwon-si (KR); Youngseok PARK, Suwon-si (KR); Donghwan BAE, Suwon-si (KR); Minsuk JANG, Suwon-si (KR)

(21) Appl. No.: 17/173,555

(22) Filed: Feb. 11, 2021

(30) Foreign Application Priority Data
Feb. 11, 2020 (KR) 10-2020-0016335

(51) Int. Cl. G06F 3/01; G06K 9/00

(52) U.S. Cl. CPC G06F 3/017; G06K 9/00375; G06K 9/00342; G06K 9/00369

(57) ABSTRACT

An electronic device includes a display device, at least one camera, a memory in which a plurality of applications are stored, and a processor configured to be operatively connected to the display device, the at least one camera, and the memory. The processor is configured to execute the plurality of applications, detect a designated gesture input based on image data acquired using the at least one camera while executing the plurality of applications, determine a type of the detected gesture input, determine a first application among the plurality of executed applications based on the determined type of the gesture input, and execute a first function of the determined first application based on the determined type of the gesture input.

### CROSS-REFERENCE TO RELATED APPLICATION

This application is based on and claims priority under 35 U.S.C. 119 to Korean Patent Application No. 10-2020-0016335 filed on Feb. 11, 2020 in the Korean Intellectual Property Office, the disclosure of which is herein incorporated by reference in its entirety.

### BACKGROUND

### 1. Field

The present disclosure relates to embodiments of methods of operating a function based on gesture recognition and electronic devices supporting the same.

### 2. Description of Related Art

Certain electronic devices are configured to receive various types of input in order to provide a more interactive and satisfying user experience. For example, an electronic device may support a gesture recognition, wherein a gesture made by the user's body is recognized as a user input. In response to the recognized gesture input, the electronic device may execute a function defined to correspond to the gesture input (for example, a function of an application).

The above information is presented as background information only to assist with an understanding of the disclosure. No determination has been made, and no assertion is made, as to whether any of the above might be applicable as prior art with regard to the disclosure.

### SUMMARY

A technical challenge associated with controlling execution of application functions by an electronic device based on gesture input recognition is that, typically, gesture based control may be limited to applications in the running in the foreground, which are explicitly indicated by a display device (for example, a display). Accordingly, in order to control the function of another application executed by the electronic device through a gesture input, another type of input (for example, a touch input) for focusing the other application to the foreground may be required, and as such, the limited applicability of gesture recognition based control to a foreground application undermines the convenience and user experience benefits of such control.

Various embodiments disclosed herein may provide a method of operating a function based on gesture recognition and an electronic device supporting the same, wherein, based on the type of a gesture input, functions related to multiple currently executed applications may be executed selectively.

An electronic device according to certain embodiments of this disclosure can include a display device; at least one camera, a memory in which a plurality of applications are stored, and a processor configured to be operatively connected to the display device, the at least one camera, and the memory.

According to various embodiments, the processor may be configured to execute the plurality of applications, detect a designated gesture input based on image data acquired using the at least one camera while executing the plurality of applications, determine a type of the detected gesture input, determine a first application among the plurality of executed applications based on the determined type of the gesture input, and execute a first function of the determined first application based on the determined type of the gesture input.

A method of operating a function based on gesture recognition of an electronic device according to certain embodiments includes executing a plurality of applications stored in a memory, detecting a designated gesture input based on image data acquired using at least one camera while executing the plurality of applications, determining a type of the detected gesture input, determining a first application among the plurality of executed applications based on the determined type of the gesture input, and executing a first function of the determined first application based on the determined type of the gesture input.

According to various embodiments, a gesture input may be provided such that selective execution of multiple functions supported by an electronic device can be controlled.

According to various embodiments, a gesture input may be provided such that various intentions may be expressed based on a combination of the posture and motion of the user's body.

Besides, various advantageous effects inferable directly or indirectly through this document may be provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates, in block diagram format, an example of an electronic device in a network environment according to certain embodiments of this disclosure;

FIG. 2 illustrates examples of various gesture inputs that can be recognized by an electronic device according to certain embodiments of this disclosure;

FIG. 3 illustrates an example of executing a function based on gesture input recognition in a first operating environment of an electronic device according to certain embodiments of this disclosure;

FIG. 4 illustrates an example of executing a function based on gesture input recognition in a first operating environment of an electronic device according to certain embodiments of this disclosure;

FIG. 5 illustrates an example of executing a function based on gesture input recognition in a first operating environment and a second operating environment of an electronic device according to certain embodiments of this disclosure;

FIG. 6 illustrates an example of executing a function based on gesture input recognition in a first operating environment and a second operating environment of an electronic device according to certain embodiments of this disclosure;

FIG. 7 illustrates an example of executing a function based on gesture input recognition in a third operating environment of an electronic device according to certain embodiments of this disclosure;

FIG. 8 illustrates an example of executing a function based on gesture input recognition in a third operating environment of an electronic device according to certain embodiments of this disclosure;

FIG. 9 illustrates examples of guide interfaces that an electronic device outputs based on gesture input recognition according to certain embodiments of this disclosure; and

FIG. 10 illustrates operations of an example method of operating a function based on gesture recognition of an electronic device according to certain embodiments of this disclosure.

In connection with the description of the drawings, the same reference numerals may be assigned to the same or corresponding components.

### DETAILED DESCRIPTION

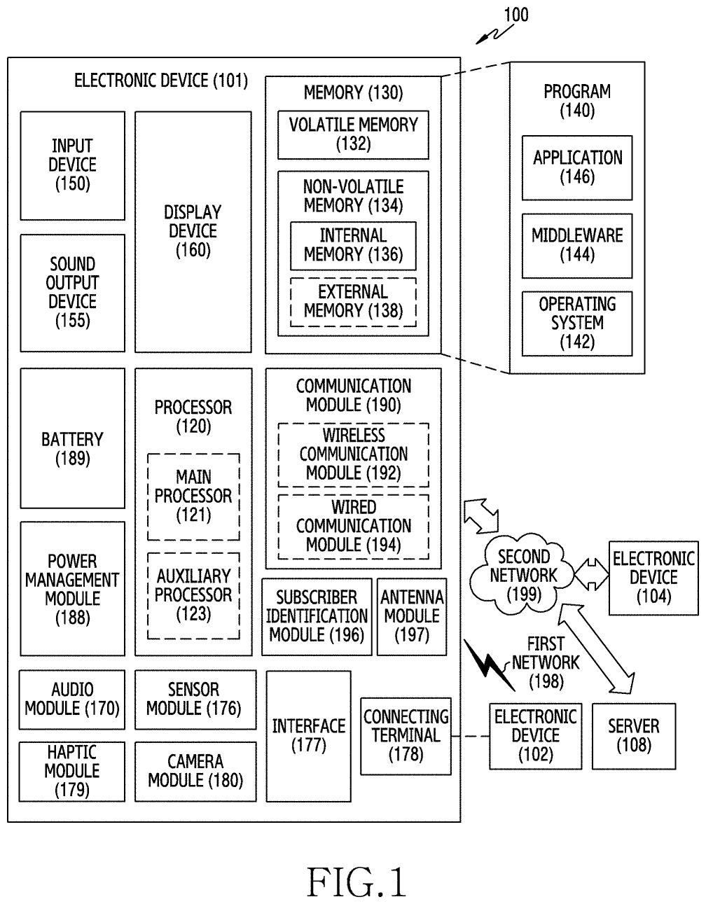

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents.

FIG. 1 illustrates, in block diagram format, an example of an electronic device in a network environment according to certain embodiments of this disclosure.

Referring to the illustrative example of FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to certain embodiments, the electronic device 101 may communicate with the electronic device 104 via the server 108. According to certain embodiments, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to certain embodiments, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to certain embodiments, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to certain embodiments, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to certain embodiments, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to certain embodiments, the audio module 170 may obtain the sound via the input device 150, or output the sound via the sound output device 155 or a headphone of an external electronic device (e.g., an electronic device 102) directly (e.g., through a wire or other physical interconnect) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to certain embodiments, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a cable or other physical connection) or wirelessly. According to certain embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to certain embodiments, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to certain embodiments, the haptic module 179 may include, for example, a motor, a piezoelectric element, or an electric stimulator.

The camera module 180 may capture a still image or moving images. According to certain embodiments, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to certain embodiments, the battery 189 may include, for example, a primary cell which is not rechargeable, a secondary cell which is rechargeable, or a fuel cell.

The communication module 190 may support establishing a direct (e.g., via a wire) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to certain embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH′, wireless-fidelity (WI-FI) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to certain embodiments, the antenna module 197 may include an antenna, the antenna including a radiating element composed of a conductive material or a conductive pattern formed in or on a substrate (e.g., PCB). According to certain embodiments, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to certain embodiments, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to certain embodiments, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to certain embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

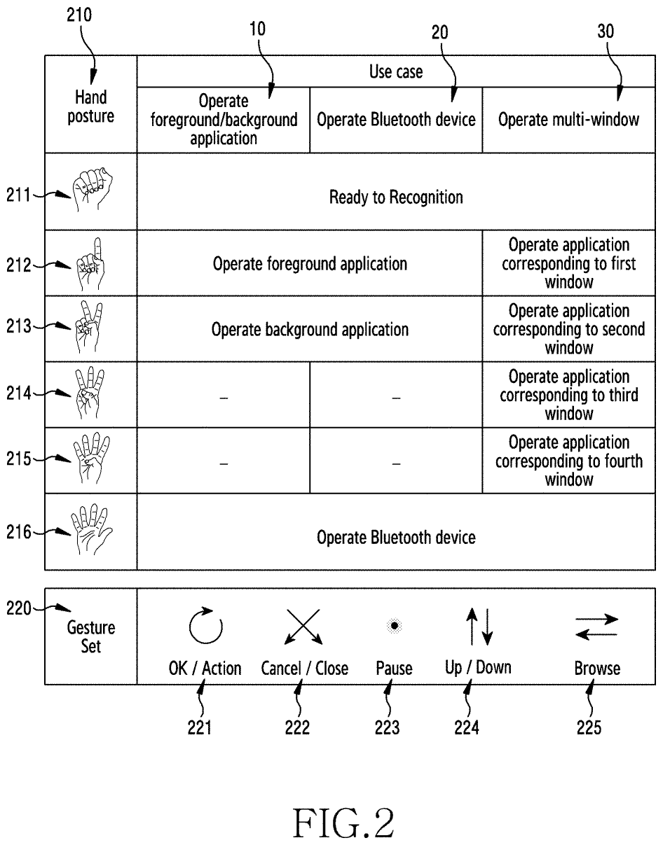

FIG. 2 illustrates examples of various gesture inputs that can be recognized by an electronic device according to certain embodiments.

In certain embodiments, an electronic device (e.g., the electronic device 101 of FIG. 1) may recognize (or detect) a gesture input by at least a part of a user's body (e.g., a hand), and may store reference data used to recognize the gesture input. In this regard, the processor (e.g., the processor 120 of FIG. 1) of the electronic device 101 may provide a user with a request for defining at least one gesture input from the electronic device 101, in an initial configuration operation for building a gesture input system. For example, the processor 120 may provide a message (e.g., a voice-based message or a text-based message) requesting a user to perform an initial gesture input by controlling a sound output device (e.g., the sound output device 155 of FIG. 1) or a display device (e.g., the display device 160 of FIG. 1). The processor 120 may acquire data on the gesture input performed by the user in response to the request. For example, the processor 120 may control at least one camera (e.g., the camera module 180 of FIG. 1) to record a video including at least a part of the user's body related to the gesture input, thereby acquiring recording data on each of the at least one gesture input.

In certain embodiments, the processor 120 may extract characteristic information from the recording data acquired for each of the at least one gesture input, and may generate reference data that can be referred to recognize (or detect) the corresponding gesture input based on the characteristic information. The processor 120 may store the reference data generated for each of the at least one gesture input in a memory (e.g., the memory 130 of FIG. 1).

According to various embodiments, in order to increase the reliability of the reference data, the processor 120 may provide a user with a request to repeatedly perform a single gesture input at a designated interval. The processor 120 may acquire a plurality of pieces of recording data for one gesture input according to gesture inputs repeatedly performed by the user in response to the request. The processor 120 may generate the reference data on the single gesture input by learning characteristic information extracted from each of the plurality of pieces of recording data.

Referring to the non-limiting example of FIG. 2, the at least one gesture input defined in the electronic device 101 may include various types. For example, each type of gesture, including the at least one gesture input may be composed of a combination of a posture 210 (e.g., a posture representing the number of fingers) that the user's body (e.g., hand) can take and a motion 220 of the user's body (e.g., dynamic motion or static motion maintained for a designated period of time). For example, one type of gesture input may be composed of a combination of a first posture 211 of the user's body and a first motion 221 of the user's body, and another type of gesture input may be composed of the first posture 211 of the user's body and a second motion 222 of the user's body. Similarly, each type of gesture comprising the at least one gesture input defined in the electronic device 101 may be composed of a combination of various postures that the user's body can take (e.g., the first posture 211, the second posture 212, a third posture 213, a fourth posture 214, a fifth posture 215, or a sixth posture 216) and various motions (e.g., the first motion 221, the second motion 222, a third motion 223, a fourth motion 224, or a fifth motion 225), and information on the type of the at least one gesture input may be stored in the memory 130.

In certain embodiments, the electronic device 101 (or the processor 120) may operate based on a gesture input in various operating environments. For example, the electronic device 101 may recognize (or detect) a gesture input to perform the corresponding operation in a first operating environment 10 in which a plurality of applications are executed in a foreground state and a background state, a second operating environment 20 adjacent to an external electronic device supporting short-range wireless communication (e.g., BLUETOOTH™) within a designated distance, and/or a third operating environment 30 in which a plurality of applications being executed through a multi-window display provided by the display device 160 are displayed in a foreground state.

In certain embodiments, differences in the posture 210 of the user's body associated with the gesture input may indicate the intention of the gesture input according to the operating environment of the electronic device 101. For example, the posture 210 of the user's body may be intended to select a specific application according to the operating environment of the electronic device 101. For example, in the first operating environment 10 of the electronic device 101 (or an environment in which the first operating environment 10 and the second operating environment 20 are operated in combination), the second posture 212 of the user's body may be intended to select an application executed in the foreground state, and the third posture 213 of the user's body may be intended to select an application executed in the background state. For another example, in the third operating environment 30 of the electronic device 101, the second posture 212 of the user's body may be intended to select an application being executed through a first window, and the third posture 213 of the user's body may be intended to select an application being executed through a second window.

In certain embodiments, the posture 210 of the user's body may be intended to operate a multimedia service through an external electronic device according to the operating environment of the electronic device 101. For example, in the second operating environment 20 of the electronic device 101 (or an environment in which the second operating environment 20, the first operating environment 10, and the third operating environment 30 are operated in combination), the sixth posture 216 of the user's body may be intended to select an external electronic device for operating the multimedia service.

Alternatively, the posture 210 of the user's body may be intended to trigger a gesture input recognition (or detection) of the electronic device 101 regardless of the operating environment of the electronic device 101. For example, in an arbitrary operating environment of the electronic device 101 (e.g., the first operating environment 10, the second operating environment 20, and/or the third operating environment 30), the first posture 211 of the user's body may be intended to load a resource (e.g., reference data) required for recognizing (or detecting) the at least one gesture input defined in the electronic device 101. In this regard, the resource (e.g., reference data) required for recognizing the gesture input according to the first posture 211 of the user's body may be pre-loaded when the electronic device 101 is reset or when at least one camera is operated.

Based on the above, the electronic device 101 (or the processor 120) may not respond to the gesture input recognized (or detected) according to the operating environment. For example, when the posture 210 of the user's body associated with the gesture input recognized in a specific operating environment of the electronic device 101 is a posture that is not defined for the specific operating environment, the electronic device 101 may not respond to the recognized gesture input. For example, in the third operating environment 30 of the electronic device 101, the fourth posture 214 of the user's body may be intended to select an application being executed through a third window, but the fourth posture 214 of the user's body is not defined in the first operating environment 10 (or an environment in which the first operating environment 10 and the second operating environment 20 are operated in combination), and therefore the electronic device 101 may not respond to a gesture input according to the fourth posture 214 of the user's body in the first operating environment 10.

In certain embodiments, the electronic device 101 (or the processor 120) may execute a function of an application based on the motion 220 of the user's body associated with a gesture input. For example, the electronic device 101 may determine an application selected according to the posture 210 of the user's body associated with a gesture input as a target application related to the execution of the function, and may execute a function corresponding to the motion 220 of the user's body for the corresponding application. In another embodiment, the electronic device 101 may execute the function of an external electronic device based on the motion 220 of the user's body associated with a gesture input. For example, the electronic device 101 may determine the external electronic device has been selected as a target electronic device for executing a function based on the posture 210 of the user's body associated with a gesture input, and may execute a function corresponding to the motion 220 of the user's body, wherein the function controls one or more operations of the corresponding external electronic device.

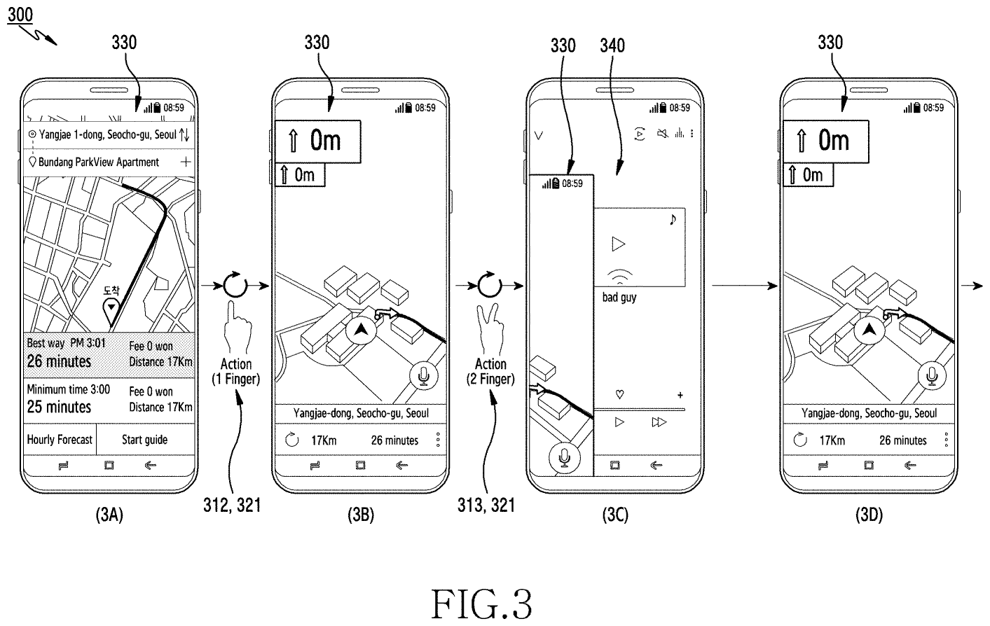

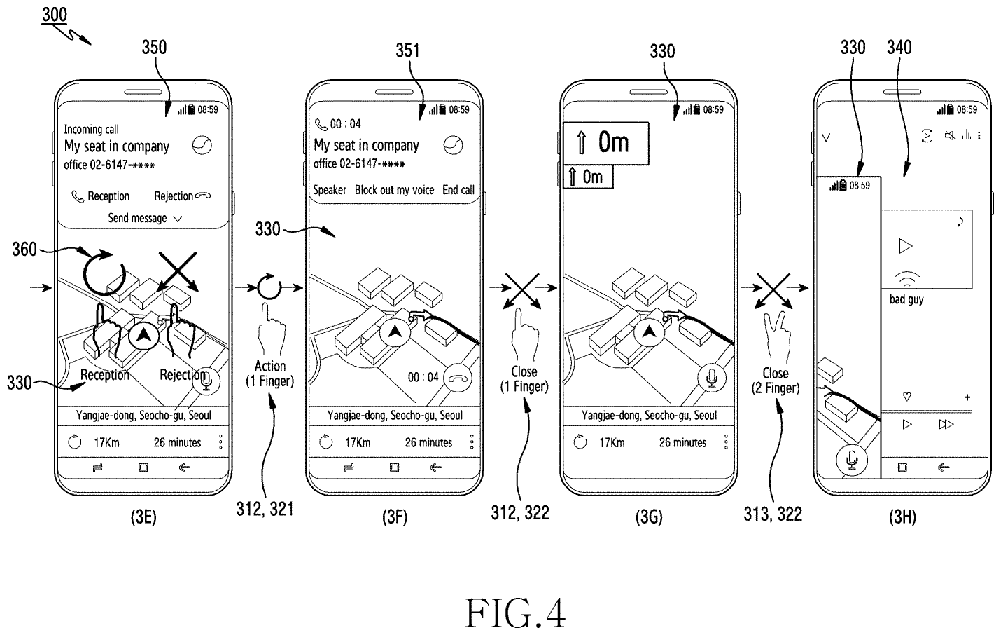

FIG. 3 illustrates an example of executing a function based on gesture input recognition in a first operating environment of an electronic device according to certain embodiments, and FIG. 4 illustrates example of executing a function based on gesture input recognition in a first operating environment of an electronic device according to certain embodiments.

Referring to the non-limiting example of FIGS. 3 and 4, an electronic device (e.g., the electronic device 101 of FIG. 1) may operate in a first operating environment (e.g., the first operating environment 10 of FIG. 2) in which a plurality of applications are executed in a foreground state and a background state (or an environment in which the first operating environment 10 and the second operating environment 20 of FIG. 2 are operated in combination), and may selectively execute functions of the plurality of applications based on the type of a recognized gesture input.

Referring to FIG. 3, at operation 3A, a processor (e.g., the processor 120 of FIG. 1) of an electronic device 300 (e.g., the electronic device 101 of FIG. 1) may execute a plurality of applications stored in a memory (e.g., the memory 130 of FIG. 1) in response to user control. According to certain embodiments, the plurality of applications may include an application in a background state which is executed at a first time point and an application in a foreground state which is executed at a second time point after the first time point, and the processor 120 may display an execution screen of a foreground application 330 by controlling a display device (e.g., the display device 160 of FIG. 1).

According to certain embodiments, the processor 120 may recognize (or detect) a first type of gesture input composed of a combination of a first motion 321 and a second posture 312 of a user's body while executing the plurality of applications. For example, the processor 120 may acquire image data by controlling at least one camera (e.g., the camera module 180 of FIG. 1) while executing the plurality of applications, and may recognize the first type of gesture input based on the image data. In this operation, the processor 120 may compare the acquired image data with reference data stored (or loaded) in the memory 130 and may recognize the first type of gesture input based on the comparison.

According to various embodiments, the processor 120 may control activation of at least one camera supporting recognition of the gesture input in response to a designated trigger point. For example, when the proximity of the user's body (e.g., proximity within a designated distance based on the electronic device 300) to the electronic device 300 is detected based on a proximity sensor included in a sensor module (e.g., the sensor module 176 of FIG. 1), the processor 120 may activate the at least one camera. As another illustrative example, when receiving a designated user utterance (e.g., “gesture”) through a microphone (e.g., always on microphone) included in an input device (e.g., the input device 150 of FIG. 1), the processor 120 may activate the at least one camera. As a further non-limiting example, when the first operating environment 10, the second operating environment 20, and/or a third operating environment (e.g., the third operating environment 30 of FIG. 2) of the electronic device 300 are established, the processor 120 may activate the at least one camera.

According to various embodiments, the gesture input recognition of the processor 120 may be implemented based on the gesture sensor included in the sensor module 176 in addition to a method using the above-described at least one camera. For example, the processor 120 may generate reference data for recognizing (or detecting) at least one gesture input using the gesture sensor, and may recognize the gesture input based on a comparison between sensing data acquired from the gesture sensor and the reference data.

According to certain embodiments, the processor 120 may determine the type of gesture input as the first type of gesture input is recognized (or detected). For example, the processor 120 may determine the second posture 312 of the user's body and the first motion 321 of the user's body associated with the recognized gesture input. According to certain embodiments, the determination of the processor 120 with respect to the second posture 312 and the first motion 321 of the user's body may include identifying an intention (e.g., selecting the foreground application 330) indicated by the second posture 312 and an intention (e.g., ok or action) indicated by the first motion 321 in the first operating environment 10 (or environment in which the first operating environment 10 and the second operating environment 20 are operated in combination) of the electronic device 300.

Referring to the non-limiting example of FIG. 3, at operation 3B, the processor 120 may determine an application based on the determined type of gesture input and may execute a function of the corresponding application. For example, the processor 120 may determine an application (e.g., the foreground application 330) corresponding to the identified intention of the second posture 312 of the user's body among the plurality of executed applications (e.g., the background application and the foreground application 330), and may execute a function corresponding to the identified intention of the first motion 321 of the user's body by focusing the determined application.

According to various embodiments, in operation 3A, an execution screen of each of the plurality of executed applications may include a plurality of graphic elements (e.g., selectable menus or buttons) to which a user input may be applied. In this regard, some graphic elements among the plurality of graphic elements may have a focusing state at the beginning of execution of the corresponding application in order for a specific motion (e.g., the first motion 321) of the user's body associated with the gesture input to be applied, and may be displayed to be distinguished from other graphic elements (e.g., flashing display or specific color display). In various embodiments, switching of focusing with respect to the plurality of graphic elements may be implemented by a separately defined gesture input (e.g., a type of gesture input consisting of a specific posture of the user's body for selecting an application and a combination of a fourth motion (for example, the fourth motion 244 of FIG. 2) and/or a fifth motion (for example, the fifth motion 225 of FIG. 2)). Based on the above description, the execution of a function corresponding to the intention of the first motion 321 of the user's body performed by the processor 120 may be applied to the graphic element having the focusing state on the execution screen of the determined foreground application 330.

According to certain embodiments, after a response to, or processing of, the first type of gesture input is completed, the processor 120 may recognize (or detect) a second type of gesture input composed of a third posture 313 and the first motion 321 of the user's body. In response to the second type of gesture input, the processor 120 may identify an intention (e.g., selecting a background application) indicated by the third posture 313 of the user's body associated with the gesture input and an intention (e.g., ok or action) indicated by the first motion 321 of the user's body in the first operating environment 10 (or environment in which the first operating environment 10 and the second operating environment 20 are provided at the same time) of the electronic device 300.

As shown in the illustrative example of FIG. 3, at operation 3C, the processor 120 may determine an application (e.g., background application) corresponding to the identified intention of the third posture 313 of the user's body among the plurality of executed applications (e.g., the background application and the foreground application 330), and may execute a function corresponding to the identified intention of the first motion 321 of the user's body by focusing the determined application. For example, the processor 120 may execute a function (e.g., multimedia playback) related to the graphic element (e.g., a multimedia playback button) having the focusing state in the determined application (e.g., the background application) based on the identified intention of the first motion 321 of the user's body.

According to certain embodiments, when it is identified that the posture of the user's body associated with the gesture input is intended to select the background application, the processor 120 may control the display device 160 to at least temporarily display the execution screen of the background application. For example, the processor 120 may switch the execution screen of the foreground application 330 to the execution screen of the background application 340 in a manner in which the execution screen of the background application 340 slides to push the execution screen of the foreground application 330. By way of illustrative example, the processor 120 may switch the execution screen of the foreground application 330 to the execution screen of the background application 340 by applying the fade-out effect to the execution screen of the foreground application 330 and applying the fade-in effect to the execution screen of the background application 340. As another illustrative example, the processor 120 may apply the fade-out effect to the execution screen of the foreground application 330 to gradually extinguish the execution screen of the foreground application 330, so that the execution screen of the background application 340 that was displayed as a lower layer on the execution screen of the foreground application 330 may be controlled to configure the entire screen of the display device 160. In some embodiments, the processor 120 may control the execution screen of the background application 340 to be overlaid on an upper layer of the execution screen of the foreground application 330 for a designated time. For another example, the processor 120 may divide the screen of the display device 160 into a plurality of areas, and may display at least a part of the execution screen of the foreground application 330 and at least a part of the execution screen of the background application 340 on each of the plurality of areas.

Referring again to the illustrative example of FIG. 3, at operation 3D, the processor 120 may stop displaying the execution screen of the background application 340 determined based on the second type of gesture input, and may display the execution screen of the foreground application 330 that has been previously displayed. For example, when a designated time elapses from starting the display of the execution screen of the background application 340 (or from switching to the execution screen of the background application 340), the processor 120 may control the display device 160 to display the execution screen of the foreground application 330 again.

Referring to the illustrative example of FIG. 4, at operation 3E, the electronic device 300 may receive a call while operating the foreground application 330. The processor 120 may display a pop-up window 350 including at least one piece of information on the reception of the call in order to provide a notification of the reception of the call. For example, the processor 120 may control the execution screen of the foreground application 330 in a background state so that the pop-up window 350 has a foreground state, and may overlap and display the pop-up window 350 on at least a part of the execution screen of the application 330 in the background state. In addition, the processor 120 may overlap and display guide information 360 guiding a gesture input for responding to the reception of the call, on at least a part of the execution screen of the application 330 switched to the background state. According to certain embodiments, the guide information 360 may include an image, text, and animation of a type of gesture input consisting of a combination of a posture and motion of a user's body intended to receive a call and a type of gesture input consisting of a combination of a posture and motion of a user's body intended to reject a call, or a combination thereof. According to various embodiments, in an operation of displaying the guide information 360, the processor 120 may blur at least a part of the execution screen of the application 330 switched to the background state or may process a layer including the guiding information 360 to be translucent or opaque in order to increase the visibility of the guide information 360.

In certain embodiments, the processor 120 may recognize (or detect) the gesture input in response to the reception of the call. For example, the processor 120 may recognize a gesture input (e.g., a type of gesture input consisting of a combination of the second posture 312 and the first motion 321 of the user's body) corresponding to a gesture input type related to the reception of the call indicated by the displayed guide information 360.

Referring to the non-limiting example of operation 3F, the processor 120 may execute a function related to the reception of the call in response to the recognized gesture input (e.g., a gesture input of a type related to call reception). For example, the processor 120 may execute a function (e.g., call reception or call connection) corresponding to the corresponding gesture input based on the type determined for the recognized gesture input. In this operation, the processor 120 may update at least one piece of information in the pop-up window 350 displayed in operation 3E based on the execution of the function, or may switch and display the pop-up window 350 to a pop-up window 351 including at least one piece of information related to the execution of the function.

According to certain embodiments, after a response to or processing of the gesture input of the type related to the call reception is completed, the processor 120 may recognize (or detect) a gesture input (e.g., a type of gesture input consisting of a combination of the second posture 312 and the second motion 322 of the user's body) corresponding to a gesture input related to a call rejection indicated by the displayed guide information 360.

Referring to the explanatory example of FIG. 4, at operation 3G, the processor 120 may execute another function related to the call reception in response to a recognized gesture input (e.g., the gesture input of the type related to the call rejection). For example, the processor 120 may execute a function (e.g., call rejection or call termination) corresponding to the gesture input based on the type determined for the recognized gesture input. The processor 120 may remove the pop-up window 351 displayed in operation 3F as at least a part of the execution of the other function, and may switch the application 330 in the background state to the foreground state.

In certain embodiments, the processor 120 may recognize (or detect) a third type of gesture input consisting of a combination of the third posture 313 and the second motion 322 of the user's body. In response to recognition of the third type of gesture input, the processor 120 may identify an intention (e.g., selecting the background application) indicated by the third posture 313 of the user's body associated with the gesture input and an intention (e.g., cancel or close) indicated by the second motion 322 of the user's body in the first operating environment 10 (or environment in which the first operating environment 10 and the second operating environment 20 are operated in combination) of the electronic device 300.

As shown in the explanatory example of FIG. 4, at operation 3H, the processor 120 may determine an application (e.g., the background application) corresponding to the identified intention of the third posture 313 of the user's body among the plurality of executed applications (e.g., the background application and the foreground application). In addition, the processor 120 may execute a function corresponding to the identified second motion 322 of the user's body by focusing the determined application. For example, the processor 120 may execute a function of terminating the execution of the determined application (e.g., the background application) based on the identified intention of the second motion 322 of the user's body.

According to certain embodiments, as the posture of the user's body associated with the recognized gesture input is identified as intended to select the background application, the processor 120 may control the display device 160 to at least temporarily display the execution screen of the background application. For example, in the same as or a similar manner to the method described in operation 3C, the processor 120 may switch the execution screen of the foreground application 330 to the execution screen of the background application 340, or may display at least a part of the execution screen of the foreground application 330 and at least a part of the execution screen of the background application 340 in each of a plurality of areas divided with respect to the screen of the display device 160. According to various embodiments, when a designated time elapses from starting the display of the execution screen of the background application 340 (or from switching to the execution screen of the background application 340), the processor 120 may stop displaying the execution screen and may display the execution screen of the foreground application 330.

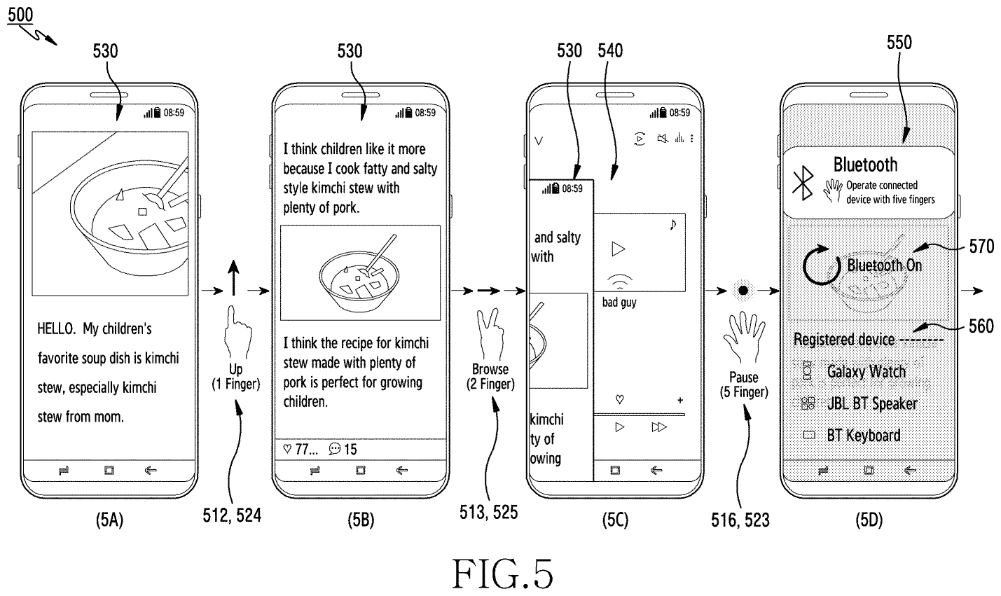

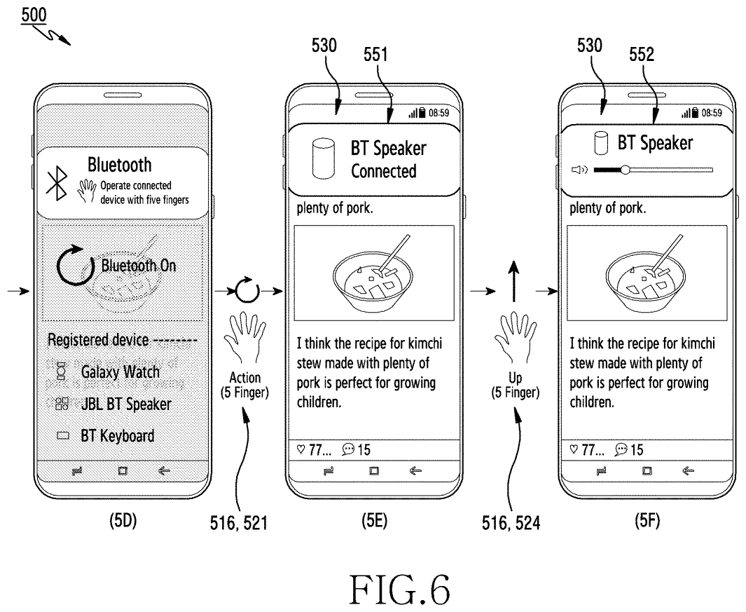

FIG. 5 illustrates an example of executing a function based on gesture input recognition in a first operating environment and a second operating environment of an electronic device according to certain embodiments, and FIG. 6 builds upon the example of FIG. 5 and provides an example of executing a function based on gesture input recognition in a first operating environment and a second operating environment of an electronic device according to certain embodiments.

In the embodiments described below with reference to FIGS. 5 and 6, an electronic device (e.g., the electronic device 101 of FIG. 1) may operate in a first operating environment (e.g., the first operating environment 10 of FIG. 2) in which a plurality of applications are executed in a foreground state and a background state and a second operating environment (e.g., the second operating environment 20 of FIG. 2) adjacent to an external electronic device that supports short-range wireless communication (e.g., BLUETOOTH′) within a designated distance, and may selectively execute functions of the plurality of applications based on a recognized type of gesture input or may operate a multimedia service through an external electronic device adjacent to the electronic device.

Referring to the explanatory example of FIG. 5, at operation 5A, the processor (e.g., the processor 120 of FIG. 1) of an electronic device 500 (e.g., the electronic device 101 of FIG. 1) may execute a plurality of applications (e.g., a foreground application and a background application), and may control a display device (e.g., the display device 160 of FIG. 1) to display the execution screen of the foreground application 530.

In certain embodiments, the processor 120 may recognize (or detect) a fourth type of gesture input consisting of a combination of a second posture 512 and a fourth motion 524 of a user's body while executing the plurality of applications. In response to the recognition of the fourth type of gesture input, the processor 120 may determine the recognized type of gesture input, and may identify an intention of the gesture input recognized as at least part of determining the type. For example, in the first operating environment 10 or the second operating environment 20 of the electronic device 500, the processor 120 may identify an intention (e.g., selecting the foreground application 530) indicated by the second posture 512 of the user's body associated with the recognized gesture input and an intention (e.g., up-scrolling in a first direction or down-scrolling in a second direction opposite the first direction) indicated by the fourth motion 524 of the user's body.

Referring to the illustrative example of FIG. 5, at operation 5B, the processor 120 may determine an application (e.g., the foreground application 530) corresponding to the identified intention of the second posture 512 of the user's body among a plurality of executed applications (e.g., the background application and the foreground application 530), and may execute a function corresponding to the identified intention of the fourth motion 524 of the user's body by focusing the determined application. For example, the processor 120 may execute a function (e.g., up-scrolling the execution screen in the first direction) of controlling the scrolling of the execution screen of the determined application (e.g., the foreground application 530) based on the intention and direction of the fourth motion 524 of the user's body.

In certain embodiments, after a response to or processing of the fourth type of gesture input is completed, the processor 120 may recognize (or detect) a fifth type of gesture input consisting of a combination of a third posture 513 and a fifth motion 525 of the user's body. In response to the recognition of the fifth type of gesture input, the processor 120 may identify an intention (e.g., selecting the background application) indicated by the third posture 513 of the user's body associated with the gesture input and an intention (e.g., browsing in a third direction or browsing in a fourth direction opposite the third direction) indicated by the fifth motion 525 of the user's body in the first operating environment 10 or the second operating environment 20 of the electronic device 500.

Referring to the illustrative example of FIG. 5, at operation 5C, the processor 120 may determine an application (e.g., the background application) corresponding to the identified intention of the third posture 513 of the user's body among the plurality of executed applications (e.g., the background application and the foreground application), and may execute a function corresponding to the identified fifth motion 525 of the user's body by focusing the determined application. For example, the processor 120 may execute a jumping function (e.g., multimedia playback sequentially after multimedia currently being executed on a multimedia playlist) related to a function (e.g., multimedia playback) being executed in the determined application, based on the identified intension and direction of the fifth motion 525 of the user's body.

In certain embodiments, as the posture of the user's body associated with the recognized gesture input is identified as intended to select the background application, the processor 120 may at least temporarily switch the execution screen of the foreground application 530 displayed through the display device 160 to the execution screen of the background application 540 in the same as or a similar to the method described through operation 3C of FIG. 3. Alternatively, the processor 120 may divide the screen of the display device 160 into a plurality of areas, and may at least temporarily display at least a part of the execution screen of the foreground application 530 and at least a part of the execution screen of the background application 540 in each of the areas. According to various embodiments, when a designated time elapses from starting the display of the execution screen of the background application 540 (or from switching to the execution screen of the background application 540), the processor 120 may stop displaying the execution screen of the background application 540, and may display the execution screen of the foreground application 530.

In certain embodiments, after a response to or processing of the fifth type of gesture input is completed, the processor 120 may recognize (or detect) a sixth type of gesture input consisting of a combination of a sixth posture 516 of the user's body and a third motion 523 maintained for a designated time or longer. In the first operating environment 10 or the second operating environment 20 of the electronic device 500, the processor 120 may identify an intention (e.g., selecting an external electronic device) indicated by the sixth posture 516 of the user's body associated with the recognized gesture input and an intention (e.g., at least temporarily pausing the operation of the foreground application 530 and displaying a guide interface related to the posture of the user's body) indicated by the third motion 523 of the user's body.

Referring again to the explanatory example of FIG. 5, at operation 5D, the processor 120 may search for at least one external electronic device supporting short-range wireless communication (e.g., BLUETOOTH™) according to the identified intention of the sixth posture 516 of the user's body. In addition, the processor 120 may switch the state of the foreground application 530 to the background state according to the identified intention of the third motion 523 of the user's body, and may control the display device 160 to display a designated guide interface. According to certain embodiments, the guide interface may include at least one piece of information on the operation of the external electronic device corresponding to the sixth posture 516 of the user's body. For example, the guide interface may include at least one of information 550 guiding the posture (e.g., the sixth posture 516) of the user's body capable of operating the external electronic device based on short-range wireless communication (e.g., BLUETOOTH™), identification information 560 of the searched at least one external electronic device (or having a history of short-range wireless communication connection with the electronic device 500), and information 570 guiding the motion (e.g., the first motion {221 of FIG. 2}) of the user's body that can be paired with the external electronic device selected by the user through short-range wireless communication.

According to certain embodiments, the processor 120 may recognize (or detect) a gesture input in response to the displayed guide interface. For example, the processor 120 may recognize a gesture input (e.g., a type of gesture input consisting of a combination of the sixth posture 516 and the first motion 521 of the user's body) corresponding to the information 550 on the posture of the user's body and the information 570 on the motion of the user's body included in the guide interface. In various embodiments, the processor 120 may further recognize (or detect) a gesture input for selecting any one of the identification information 560 of the at least one external electronic device included in the guide interface. For example, the processor 120 may recognize a type of gesture input consisting of a combination of the sixth posture 516 and a fourth motion (e.g., the fourth motion 224 of FIG. 2) of the user's body, and may focus the identification information of the external electronic device to be paired with the electronic device 500 based on the intention (e.g., up in a first direction and down in a second direction opposite the first direction) of the fourth motion 224.

Referring to the non-limiting example of FIG. 6, at operation 5E, the processor 120 may execute a related function corresponding to the recognized gesture input (e.g., a gesture input consisting of a combination of the posture (the sixth posture 516) of the user's body capable of operating an external electronic device and the motion (the first motion 521) of the user's body capable of being paired with the external electronic device). For example, the processor 120 may execute a function (e.g., establishing short-range wireless communication with an external electronic device corresponding to the focused identification information) corresponding to the corresponding gesture input, based on the type determined for the recognized gesture input. When the execution of the function is completed, the processor 120 may stop displaying the guide interface displayed in operation 5D, and may display a pop-up window 551, including pairing (or connection) information with the external electronic device to provide notification of the executed function. For example, the processor 120 may control the execution screen of the foreground application 530 in the background state so that the pop-up window 551 has the foreground state, and may superimpose and display the pop-up window 551 on at least a part of the execution screen of the application 530 in the background state. In addition, the processor 120 may transmit data related to the multimedia played through the background application 540 in operation 5C to the external electronic device paired (or connected) using the short-range wireless communication.

In certain embodiments, in a state in which the pairing (or connection) with the external electronic device based on the short-range wireless communication (e.g., Bluetooth) is completed, the processor 120 may recognize (or detect) a seventh type of gesture input consisting of a combination of the sixth posture 516 and the fourth motion 524 of the user's body. In response to the recognition of the seventh type of gesture input, in the first operating environment 10 or the second operating environment 20 of the electronic device 500, the processor 120 may identify an intention (e.g., selecting an external electronic device) indicated by the sixth posture 516 of the user's body associated with the gesture input and an intention (e.g., volume-up or volume-down) indicated by the fourth motion 524 of the user's body.

As shown in the illustrative example of FIG. 6, at operation 5F, the processor 120 may determine the external electronic device paired (or connected) with the electronic device 500 to be a target of the execution of a function corresponding to the fourth motion 524 of the user's body according to the identified intention of the sixth posture 516 of the user's body, and may execute the function with respect to the determined external electronic device. For example, the processor 120 may execute a function (e.g., transmitting a sound control signal or data to the external electronic device) of controlling (e.g., volume-up) sound for the multimedia output (or playback) of the determined external electronic device, based on the identified intention and direction of the fourth motion 524 of the user's body. In this regard, the processor 120 may display a pop-up window 552 including sound control information on the multimedia output of the external electronic device. For example, the processor 120 may control the execution screen of the foreground application 530 in the background state so that the pop-up window 552 has the foreground state, and may superimpose and display the pop-up window 552 on at least a part of the execution screen of the application 530 in the background state.

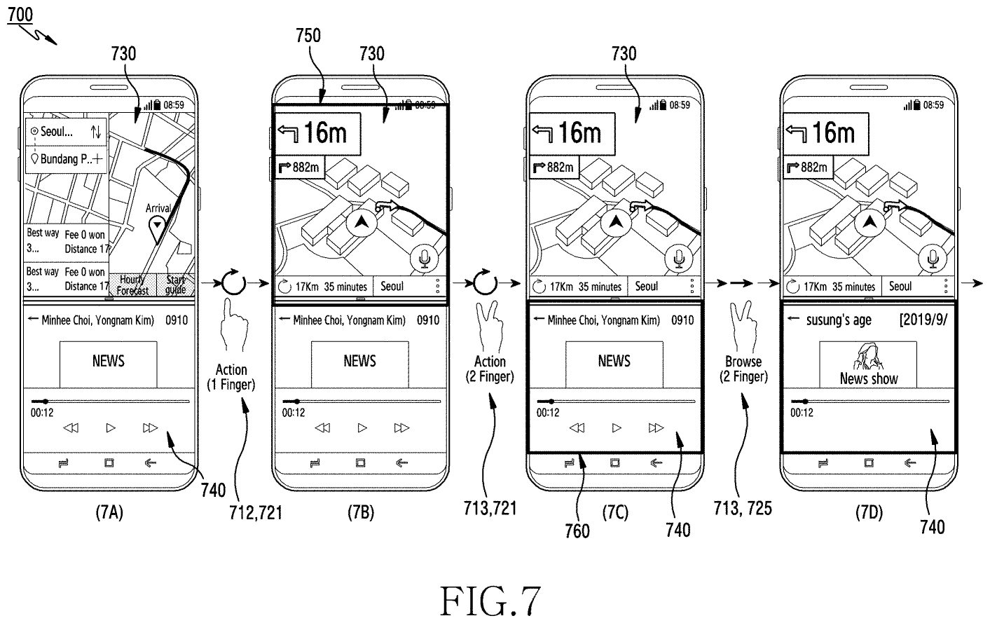

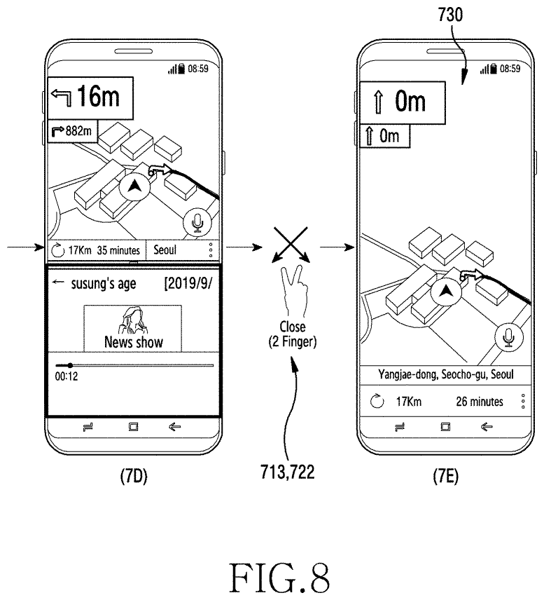

FIG. 7 illustrates an example of executing a function based on gesture input recognition in a third operating environment of an electronic device according to certain embodiments, and FIG. 8 further illustrates an example of executing a function based on gesture input recognition in a third operating environment of an electronic device according to certain embodiments.

In the non-limiting example described below with reference to FIGS. 7 and 8, an electronic device (e.g., the electronic device 101 of FIG. 1) may operate in a third operating environment (e.g., the third operating environment 30 of FIG. 2) in which a plurality of applications are displayed in a foreground state through a multi-window included in a display device (e.g., the display device 160 of FIG. 1), and may selectively execute functions of the plurality of applications based on a recognized type of gesture input.

Referring to the illustrative example of FIG. 7, in operation 7A, a processor (e.g., the processor 120 of FIG. 1) of an electronic device 700 (e.g., the electronic device 101 of FIG. 1) may execute a plurality of applications. For example, the processor 120 may control the display device 160 to display an execution screen of a first application 730 and an execution screen of a second application 740 on each of the multi-window displays (e.g., a first window and a second window) provided by the display device 160.

According to certain embodiments, the processor 120 may recognize (or detect) an eighth type of gesture input consisting of a combination of a second posture 712 and a first motion 721 of a user's body while executing the plurality of applications through the multi-window display. In response to the recognition of the eighth type of gesture input, the processor 120 may identify an intention (e.g., selecting an application displayed through a first window) indicated by the second posture 712 of the user's body associated with a gesture input recognized in the third operating environment 30 of the electronic device 700 and an intention (e.g., ok or action) indicated by the first motion 721 of the user's body.

Referring to the explanatory example of FIG. 7, at operation 7B, the processor 120 may determine the application based on the determined type of gesture input, and may execute a function of the corresponding application. For example, the processor 120 may determine an application (e.g., the first application 730 displayed through the first window) corresponding to the identified intention of the second posture 712 of the user's body among the plurality of executed applications (e.g., the first application and the second application). In this regard, at least one of the number of windows, window arrangement, window sequence, and window layout of the multi-window display provided by the display device 160 may be predefined on the electronic device 700 by user configuration. The processor 120 may determine a window corresponding to the intention of the second posture 712 of the user's body and an application displayed through the window based on the information defined for the multi-window display, and may execute a function corresponding to the identified intention of the first motion 721 of the user's body by focusing the determined application. According to certain embodiments, the execution screen of the determined application (e.g., the first application 730 displayed through the first window) may include a plurality of graphic elements (e.g., selectable menus or buttons) to which a user input can be applied, and the processor 120 may execute a function of selecting the graphic element having a focusing state from among the plurality of graphic elements based on the intention of the first motion 721.

According to various embodiments, the processor 120 may display a designated highlight object on a window (e.g., the first window) corresponding to the determined application in order to provide notification of an application (e.g., the first application 730 displayed through the first window) determined based on the posture (e.g., the second posture 712) of the user's body. For example, the processor 120 may display a highlight object 750 that at least partially overlaps the layout of a window displaying the execution screen of the determined application.

In certain embodiments, after a response to or processing of the eighth type of gesture input is completed, the processor 120 may recognize (or detect) a ninth type of gesture input consisting of a combination of the third posture 713 and the first motion 721 of the user's body. In the third operating environment 30 of the electronic device 700, the processor 120 may identify an intention (e.g., selecting an application displayed through the second window) indicated by the third posture 713 of the user's body which is associated with the ninth type of gesture input and an intention (e.g., “ok” or an action to be undertaken by an application) indicated by the first motion 721 of the user's body.

Referring to the non-limiting example of FIG. 7, at operation 7C, the processor 120 may determine an application (e.g., the second application 740 displayed through the second window) corresponding to the identified intention of the third posture 713 of the user's body among the plurality of executed applications (e.g., the first application and the second application), and may execute a function corresponding to the identified intention of the first motion 721 of the user's body by focusing the determined application. For example, the processor 120 may execute a function (e.g., multimedia playback) related to a graphic element (e.g., multimedia playback button) having a focusing state in the determined application based on the identified intention of the first motion 721 of the user's body.

According to certain embodiments, the processor 120 may display the highlight object 760 on a window (e.g., the second window) corresponding to the determined application in order to provide notification of the application (e.g., the second application 740 displayed through the second window) determined based on the posture (e.g., the third posture 713) of the user's body. For example, as the focusing of the application is changed by the ninth type of gesture input, the processor 120 may remove the highlight object 750 displayed in operation 7B, and may display a highlight object 760 on a window (e.g., the second window) corresponding to an application (e.g., the second application 740 displayed through the second window) determined based on the ninth type of gesture input.

In certain embodiments, after a response to or processing of the ninth type of gesture type is completed, the processor 120 may recognize (or detect) a tenth type of gesture input consisting of a combination of the third posture 713 and a fifth motion 725 of the user's body. In response to the recognition of the tenth type of gesture input, the processor 120 may identify an intention (e.g., selecting an application displayed through the second window) indicated by the third posture 713 of the user's body associated with the gesture input and an intention (e.g., browsing in a third direction or browsing in a fourth direction opposite the third direction) indicated by the fifth motion 725 of the user's body in the third operating environment 30 of the electronic device 700.

Referring to the non-limiting examples of FIGS. 7 and 8, at operation 7D (shown in both FIGS. 7 and 8 for continuity), the processor 120 may determine an application (e.g., the second application 740 displayed through the second window) corresponding to the identified intention of the third posture 713 of the user's body among a plurality of applications (e.g., the first application and the second application) displayed through a multi-window display. In addition, the processor 120 may execute a function corresponding to the identified intention of the fifth motion 725 of the user's body by focusing the determined application. For example, the processor 120 may execute a jumping function (e.g., multimedia playback sequentially after multimedia currently being executed on a multimedia playlist) related to a function (e.g., multimedia playback) being executed in the determined application, based on the identified intension and direction of the fifth motion 725 of the user's body.

In certain embodiments, the processor 120 may recognize (or detect) an eleventh type of gesture input. For example, the processor 120 may recognize the eleventh type of gesture input consisting of a combination of the third posture 713 and a second motion 722 of the user's body. In response to the recognition of the eleventh type of gesture input, the processor 120 may identify an intention (e.g., selecting an application displayed through the second window) indicated by the third posture 713 of the user's body and an intention (e.g., cancel and close) indicated by the second motion 722 of the user's body in the third operating environment 30 of the electronic device 700.

Referring to the non-limiting example of FIG. 8, at operation 7E, the processor 120 may determine an application (e.g., the second application displayed through the second window) corresponding to the identified intention of the third posture 713 of the user's body, and may execute a function corresponding to the identified intention of the second motion 722 of the user's body by focusing the determined application. For example, the processor 120 may execute a function (or a function of terminating a function {multimedia playback} being executed in the determined application) of terminating the execution of the determined application (e.g., the second application displayed through the second window) based on the identified intention of the second motion 722 of the user's body.

According to various embodiments, when terminating the execution of a specific application (e.g., the second application displayed through the second window) according to the recognized gesture input, the processor 120 may determine the number of applications being executed in the electronic device 700. When it is determined that a single application is being executed in the electronic device 700, the processor 120 may switch a multi-window display to a single window by controlling the display device 160. The processor 120 may display the execution screen of the single application (e.g., the first application 730) being executed, through the single window.

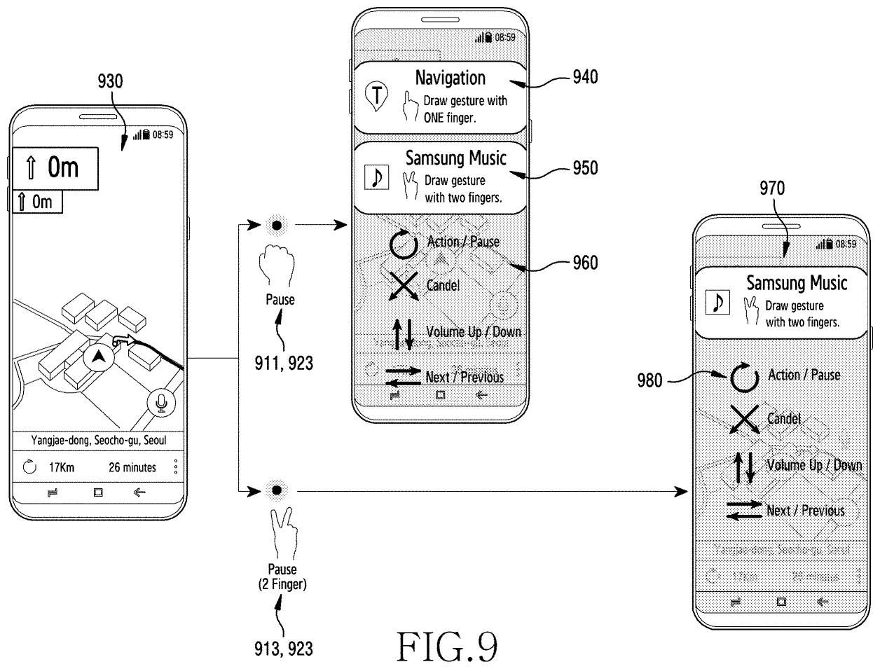

FIG. 9 illustrates examples of guide interfaces that an electronic device outputs based on gesture input recognition according to certain embodiments.

Referring to the illustrative example of FIG. 9, when recognizing (or detecting) a designated type of gesture input, a processor (e.g., the processor 120 of FIG. 1) of an electronic device (e.g., the electronic device 101 of FIG. 1) may execute the related function (e.g., displaying a guide interface) based on at least a part of the recognized gesture input. For example, the processor 120 may recognize the designated type of gesture input consisting of a combination of an arbitrary posture of a user's body and a third motion 923 of the user's body maintained for a designated time. In this case, the processor may display a guide interface corresponding to the posture of the user's body based on an intention (e.g., at least temporarily pausing the operation of a foreground application and displaying a guide interface related to the posture of the user's body) indicated by the third motion 923 of the user's body.

For example, the processor 120 may recognize the designated type of gesture input consisting of a combination of a first posture 911 of the user's body and the third motion 923 of the user's body maintained for a designated time. In this case, the processor 120 may at least temporarily pause the operation of a foreground application 930 (e.g., a foreground application executed through a single window or a foreground application presented through a multi-window display) being executed, and may display a guide interface including information on the operation of at least one application (e.g., the foreground application, the foreground application and the background application, or the foreground application executed through the multi-window) being executed in the electronic device 101. According to certain embodiments, the guide interface may include identification information of the at least one application being executed in the electronic device 101 and information 940 and/or 950 for guiding the posture of the user's body for operating (or selecting) each application according to the operating environment of the electronic device 101. In addition, the guide interface may further include information 960 for guiding various motions of the user's body for controlling functions related to the at least one application.

For another example, the processor 120 may recognize the designated type of gesture input consisting of a combination of a specific posture (e.g., the third posture 913) of the user's body and the third motion 923 of the user's body maintained for a designated time. In response to the recognition of the designated type of gesture input, the processor 120 may at least temporarily pause the operation of the foreground application 930 (e.g., the foreground application executed through a single window or the foreground application executed in a multi-window display) being executed, and may display the guide interface including information on the operation of the application corresponding to the specific posture of the user's body. According to certain embodiments, the guide interface may include identification information of an application (e.g., the background application or the foreground application executed through the second window) related to the specific posture of the user's body according to the operating environment of the electronic device 101 and information 970 for guiding the posture of the user's body for operating (or selecting) the corresponding application. In addition, the guide interface may further include information 980 for guiding various motions of the user's body for controlling functions of the application related to the specific posture of the user's body.

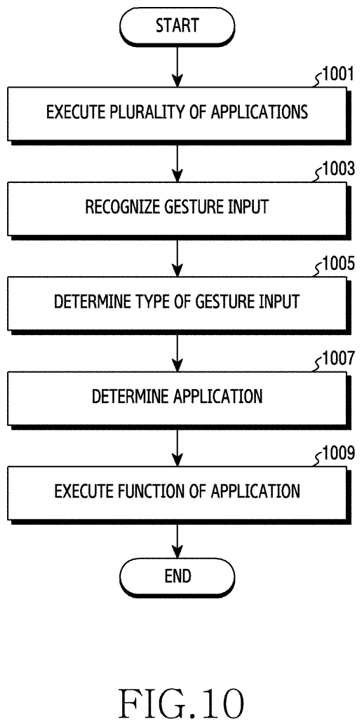

FIG. 10 illustrates operations of an example method of operating a function based on gesture recognition of an electronic device according to certain embodiments.

Hereinafter, operations described with reference to FIG. 10 may be the same as or similar to the operations of the electronic device (e.g., the electronic device 101 of FIG. 1) or the processor (e.g., the processor 120 of FIG. 1) described with reference to the preceding drawings, and thus the redundant descriptions may be omitted.

Referring to the non-limiting example of FIG. 10, in operation 1001, a processor (e.g., the processor 120 of FIG. 1) of an electronic device (e.g., the electronic device 101 of FIG. 1) may execute a plurality of applications stored in a memory (e.g., the memory 130 of FIG. 1) in response to user control. For example, the processor 120 may execute at least one application in a background state and an application in a foreground state, and may control a display device (e.g., the display device 160 of FIG. 1) to execute an execution screen of the foreground application. For another example, the processor 120 may execute the plurality of applications in the foreground state, and may display the execution screen of a plurality of foreground applications on each window of the multi-window display provided by the display device 160.

In operation 1003, the processor 120 may recognize (or detect) a gesture input defined in the electronic device 101 while executing the plurality of applications. In this regard, the processor 120 may acquire image data including at least a part of the user's body using at least one camera (e.g., the camera module 180 of FIG. 1) activated by a designated trigger point (e.g., proximity of the user's body to the electronic device 101, receiving a designated user's utterance, or creating an operating environment for the designated electronic device 101), and may compare the image data with reference data used to recognize the gesture input. The processor 120 may recognize a gesture input consisting of a combination of a specific posture and a specific motion of the user's body based on the comparison.

In operation 1005, the processor 120 may determine the type of the recognized gesture input. For example, the processor 120 may recognize the specific posture and specific motion of the user's body associated with the gesture input, and may identify an intention indicated by each of the specific posture and the specific motion in the operating environment (e.g., the first operating environment 10, the second operating environment 20, and the third operating environment 30 of FIG. 2) of the electronic device 101.

In operation 1007, the processor 120 may determine a specific application among the plurality of applications being executed based on the determined type of the gesture input. For example, the processor 120 may determine a first application corresponding to a specific posture of the user's body among the plurality of executed applications. For example, when the plurality of applications are executed in a foreground state and a background state and the identified intention of the specific posture of the user's body indicates selection of the foreground application, the processor 120 may determine the foreground application being executed to be the first application and may focus the first application. For another example, when the plurality of applications are executed in the foreground state through a multi-window display provided by the display device 160 and the identified intention of the specific posture of the user's body indicates selection of an application being executed (or displayed) through the first window, the processor 120 may determine the application being executed through the first window to be the first application and may focus the first application.

In operation 1009, the processor 120 may execute a function related to the first application. For example, the processor 120 may determine the focused first application to be a target application for executing a function related to a specific motion of the user's body associated with the recognized gesture input, and may execute a function indicated by the identified intention of the specific motion of the user's body for the first application. In this regard, the execution screen of the plurality of applications may include a plurality of graphic elements (e.g., selectable menus or buttons) to which a user input is applied, and some of the plurality of graphic elements may have a focusing state so that the specific motion of the user's body can be applied thereto. Accordingly, the processor 120 may execute the function related to the graphic element having the focusing state on the execution screen of the first application based on the identified intention of the specific motion of the user's body. Alternatively, regardless of the graphic element having the focusing state, the processor 120 may execute a function of terminating the first application based on the identified intention of the specific motion of the user's body (or terminating a function being executed in the first application), a function of controlling scrolling on the execution screen of the first application, or a function of controlling a function (e.g., multimedia playback) being executed in the first application.

An electronic device according to the various embodiments described above may include a display device, at least one camera, a memory in which a plurality of applications are stored, and a processor that is operatively connected to the display device, the at least one camera, and the memory.

According to various embodiments, the processor may execute the plurality of applications, may detect a designated gesture input based on image data acquired using the at least one camera while executing the plurality of applications, may determine a type of the detected gesture input, may determine a first application among the plurality of executed applications based on the determined type of the gesture input, and may execute a first function of the determined first application based on the determined type of the gesture input.

According to various embodiments, as at least a part of determining the type of the detected gesture input, the processor may determine a posture and a motion of a user's body associated with the detected gesture input.

According to various embodiments, the processor may operate in a first operating environment in which the plurality of applications are executed in a foreground state and a background state.

According to various embodiments, when the posture of the user's body is determined to be a first posture, the processor may determine the application in the foreground state to be the first application.

According to various embodiments, when the posture of the user's body is determined to be a second posture, the processor may determine the application in the background state to be the first application.

According to various embodiments, when the posture of the user's body is determined to be the second posture, the processor may control the display device to at least temporarily switch and display an execution screen of the application in the foreground state to an execution screen of the application in the background state.

According to various embodiments, when the posture of the user's body is determined to be the second posture, the processor may divide a screen of the display device into a plurality of areas, and may at least temporarily display the execution screen of the application in the foreground state and the execution screen of the application in the background state on each of the plurality of areas.

According to various embodiments, the display device may include a multi-window display.

According to various embodiments, the processor may operate in a second operating environment in which the plurality of applications are executed in the foreground state through the multi-window display.

According to various embodiments, when the posture of the user's body is determined to be a third posture, the processor may determine the application executed through a first window corresponding to the third posture to be the first application.

According to various embodiments, when the posture of the user's body is determined to be a fourth posture, the processor may determine the application executed through a second window corresponding to the fourth posture to be the first application.

According to various embodiments, the processor may display a highlight object at least partially overlapping a layout of the first window or the second window through which the determined first application is executed.

According to various embodiments, when the motion of the user's body is determined to be a first motion, the processor may execute the first function of selecting a graphic element having a focusing state on an execution screen of the first application.

According to various embodiments, when the motion of the user's body is determined to be a second motion, the processor may execute the first function of terminating the execution of the first application or the first function of terminating a second function being executed in the first application.

According to various embodiments, when the motion of the user's body is determined to be a third motion maintained for a designated time, the processor may at least temporarily pause the operation of the application in the foreground state among the plurality of applications, and may display a guide interface including at least one piece of information on the operation of the application related to the posture of the user's body.

According to various embodiments, when the motion of the user's body is determined to be a fourth motion, the processor may execute the first function of controlling scrolling on the execution screen of the first application based on a direction of the fourth motion.

According to various embodiments, when the motion of the user's body is determined to be a fifth motion, the processor may execute the first function of jumping to a third function being executed in the first application based on a direction of the fifth motion.

A method of operating a function based on gesture recognition of the above-described electronic device according to various embodiments may include executing a plurality of applications stored in a memory, detecting a designated gesture input based on image data acquired using at least one camera while executing the plurality of applications, determining a type of the detected gesture input, determining a first application among the plurality of executed applications based on the determined type of the gesture input, and executing a first function of the determined first application based on the determined type of the gesture input.

According to various embodiments, the determining the type of the detected gesture input may include determining a posture of a user's body associated with the detected gesture input and determining a motion of the user's body associated with the detected gesture input.

According to various embodiments, the electronic device may operate in a first operating environment in which the plurality of applications are operated in a foreground state and a background state.

According to various embodiments, the determining the first application may include determining the application in the foreground state to be the first application when the posture of the user's body is determined to be a first posture and determining the application in the background state to be the first application when the posture of the user's body is determined to be a second posture.

According to various embodiments, the electronic device may operate in a second operating environment in which the plurality of applications are executed in the foreground state through a multi-window display provided by a display device.

According to various embodiments, the determining the first application may include: determining, when the posture of the user's body is determined to be a third posture, the application executed through a first window corresponding to the third posture to be the first application; and determining, when the posture of the user's body is determined to be a fourth posture, the application executed through a second window corresponding to the fourth posture to be the first application.

According to various embodiments, the executing the first function may include executing the first function of selecting a graphic element having a focusing state on an execution screen of the first application when the motion of the user's body is determined to be a first motion.

According to various embodiments, the executing the first function may include executing the first function of terminating the execution of the first application or the first function of terminating a second function being executed in the first application when the motion of the user's body is determined to be a second motion.

According to various embodiments, the executing the first function may include executing, when the motion of the user's body is determined to be a third motion, the first function of controlling scrolling on the execution screen of the first application based on a direction of the third motion.

According to various embodiments, the executing the first function may include executing, when the motion of the user's body is determined to be a fourth motion, the first function of jumping to a third function being executed in the first application based on a direction of the fourth motion.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to certain embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., through a wire), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to certain embodiments, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to certain embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a display device;
at least one camera;
a memory in which a plurality of applications are stored; and
a processor configured to be operatively connected to the display device, the at least one camera, and the memory,
wherein the processor is configured to:
execute the plurality of applications;
detect a designated gesture input based on image data acquired using the at least one camera while executing the plurality of applications;
determine a type of the detected gesture input;
determine a first application among the plurality of executed applications based on the determined type of the designated gesture input; and
execute a first function of the determined first application based on the determined type of the designated gesture input.

2. The electronic device of claim 1, wherein the processor is configured to:
determine a posture and a motion of a user's body associated with the detected gesture input as at least a part of determining the type of the detected gesture input.

3. The electronic device of claim 2, wherein the processor is configured to:
operate in a first operating environment in which the plurality of applications comprise applications executed in a foreground state and a background state;
determine, when the posture of the user's body is determined to be a first posture, the application in the foreground state to be the first application; and
determine, when the posture of the user's body is determined to be a second posture, the application in the background state to be the first application.

4. The electronic device of claim 3, wherein the processor is configured to:
control the display device to at least temporarily switch and display an execution screen of the application in the foreground state to an execution screen of the application in the background state, when the posture of the user's body is determined to be a second posture.

5. The electronic device of claim 3, wherein the processor is configured to:
divide, when the posture of the user's body is determined to be the second posture, a screen of the display device into a plurality of areas, and at least temporarily display an execution screen of the application in the foreground state and an execution screen of the application in the background state on each of the plurality of areas.

6. The electronic device of claim 2, wherein
the display device provides a multi-window display, and
the processor is configured to:
operate in a second operating environment in which the plurality of applications comprise applications executed in a foreground state of the multi-window display;
determine, when the posture of the user's body is determined to be a third posture, an application executed through a first window corresponding to the third posture to be the first application; and
determine, when the posture of the user's body is determined to be a fourth posture, an application executed through a second window corresponding to the fourth posture to be the first application.

7. The electronic device of claim 6, wherein the processor is configured to:
display a highlight object at least partially overlapping a layout of the first window or the second window through which the determined first application is executed.

8. The electronic device of claim 2, wherein the processor is configured to:
execute, when the motion of the user's body is determined to be a first motion, the first function of selecting a graphic element having a focusing state on an execution screen of the first application.

9. The electronic device of claim 2, wherein the processor is configured to:
execute, when the motion of the user's body is determined to be a second motion, the first function of terminating execution of the first application or the first function of terminating a second function being executed in the first application.

10. The electronic device of claim 2, wherein the processor is configured to:
at least temporarily pause, when the motion of the user's body is determined to be a third motion maintained for a designated time, operation of an application in a foreground state among the plurality of applications; and
display a guide interface including at least one piece of information on operation of an application related to the posture of the user's body.

11. The electronic device of claim 2, wherein the processor is configured to:
execute, the motion of the user's body is determined to be a fourth motion, the first function of controlling scrolling on an execution screen of the first application based on a direction of the fourth motion.

12. The electronic device of claim 2, wherein the processor is configured to:
execute, when the motion of the user's body is determined to be a fifth motion, the first function of jumping to a third function being executed in the first application based on a direction of the fifth motion.

13. A method of operating a function based on gesture recognition of an electronic device, the method comprising:
executing a plurality of applications stored in a memory;
detecting a designated gesture input based on image data acquired using at least one camera while executing the plurality of applications;
determining a type of the detected gesture input;
determining a first application among the plurality of executed applications based on the determined type of the designated gesture input; and
executing a first function of the determined first application based on the determined type of the designated gesture input.

14. The method of claim 13, wherein determining the type of the detected gesture input comprises:
determining a posture of a user's body associated with the detected gesture input; and
determining a motion of the user's body associated with the detected gesture input.

15. The method of claim 14, wherein:
the electronic device operates in a first operating environment in which the plurality of applications comprises applications operating in a foreground state and a background state, and
determining the first application comprises:
determining an application in the foreground state to be the first application when the posture of the user's body is determined to be a first posture; and
determining an application in the background state to be the first application when the posture of the user's body is determined to be a second posture.

16. The method of claim 14, wherein
the electronic device operates in a second operating environment in which the plurality of applications are executed in a foreground state of a multi-window display provided by a display device, and
determining the first application comprises:
determining, when the posture of the user's body is determined to be a third posture, an application executed through a first window corresponding to the third posture to be the first application; and
determining, when the posture of the user's body is determined to be a fourth posture, an application executed through a second window corresponding to the fourth posture to be the first application.

17. The method of claim 14, wherein executing the first function comprises:
executing the first function of selecting a graphic element having a focusing state on an execution screen of the first application when the motion of the user's body is determined to be a first motion.

18. The method of claim 14, wherein executing the first function comprises:
executing the first function of terminating the execution of the first application or the first function of terminating a second function being executed in the first application when the motion of the user's body is determined to be a second motion.

19. The method of claim 14, wherein executing the first function comprises:
executing, when the motion of the user's body is determined to be a third motion, the first function of controlling scrolling on an execution screen of the first application based on a direction of the third motion.

20. The method of claim 14, wherein the executing the first function comprises:
executing, when the motion of the user's body is determined to be a fourth motion, the first function of jumping to a third function being executed in the first application based on a direction of the fourth motion.
